(19) United States
(12) Patent Application Publication
(10) Pub. No.: US 2013/0181408 A1
(43) Pub. Date: Jul. 18, 2013

(54) BRUSH SEAL ARRANGEMENT COMBINED WITH HONEYCOMB SEAL

(71) Applicants: Srinivasa Rao Pakkala, Chintalapudi (IN); John Clisby Blanton, Simpsonville, SC (US); Karimulla Sha Shaik, Anantapur (IN)

(72) Inventors: Srinivasa Rao Pakkala, Chintalapudi (IN); John Clisby Blanton, Simpsonville, SC (US); Karimulla Sha Shaik, Anantapur (IN)

(73) Assignee: GENERAL ELECTRIC COMPANY, Schenectady, NY (US)

(21) Appl. No.: 13/350,011

(22) Filed: Jan. 13, 2012

(51) Int. Cl. F16J 15/16; F16J 15/447; F01D 11/02; F16J 15/44

(52) U.S. Cl. 277/347; 277/345; 277/355

(57) ABSTRACT

A hybrid seal carrier for establishing a seal between a rotating component and a stationary component substantially surrounding the rotating component includes a first seal element held between forward and aft end plates and adapted to be seated within a first slot formed in the stationary component. A second seal element is seated within a second slot formed in one of the forward or aft end plate; wherein said first seal element comprises a plurality of bristles forming a brush seal; and said second seal element comprises at least one honeycomb seal.

### BACKGROUND OF THE INVENTION

The invention relates to rotary machine seals and, specifically, to seals between stationary and rotating turbine components.

Rotary machines, such as steam and gas turbines, used for power generation and mechanical drive applications are generally large machines consisting of multiple turbine stages. In rotary machines, seals between the stationary and rotating components are used to control leakage between regions of high and low pressures. The efficiency of the rotary machine is directly dependent on the ability of the seals to minimize leakage, e.g., between the rotor and stator.

Traditionally, rigid labyrinth seals of either a hi-lo, stepped, or straight shaft design are used. These types of seals are employed at virtually all rotor machine locations where leakage between rotating and stationary components must be controlled. In a turbine, for example, this includes interstage shaft seals, rotary end seals, and bucket (or blade) tip seals. Steam turbines of both impulse and reaction designs typically employ rigid, sharp teeth for rotor/stator sealing. While labyrinth seals have proved to be quite reliable, their performance degrades over time as a result of transient events in which the stationary and rotating components interfere, rubbing the labyrinth teeth into a “mushroom” profile and/or abrading the stator surfaces, thus opening the seal clearance.

Another type of seal used in many environments, including rotary machines, is a brush seal. Brush seals are generally more resistant to leakage than labyrinth seals. A brush seal can also accommodate relative radial movement between fixed and rotational components, for example, between a rotor and a stator, because of the flexibility of the seal bristles. Brush seals also generally conform better to surface non-uniformities. The result of using brush seals is better sustained rotary machine performance than is generally possible with labyrinth seals.

Abradable honeycomb seal lands are also sometimes employed with labyrinth seals to seal the radial gap between stationary and rotary components in turbines. In addition, brush seals have been combined with honeycomb/labyrinth seals in a hybrid arrangement described in, for example, U.S. Pat. No. 6,827,350.

There remains a need, however, for effective hybrid seals with a more compact design and that can enable tighter cold gaps between the stationary and rotary turbine components, and that facilitate assembly and/or replacement of the seal components.

### BRIEF DESCRIPTION

Accordingly, in a first exemplary but nonlimiting embodiment, the present invention provides a hybrid seal carrier for establishing a seal between a rotating component and a stationary component substantially surrounding the rotating component, the hybrid seal carrier comprising a first seal element held between forward and aft end plates and adapted to be held within a first slot formed in the stationary component; and a second seal element seated within a second slot formed in one of the forward and aft end plates.

In another aspect, the present invention provides a hybrid seal carrier mounted between a rotating component and a stationary component substantially surrounding the rotating component, the hybrid seal carrier comprising a brush seal held between forward and aft end plates seated within a first substantially T-shaped slot formed in the stationary component; a seal carrier extension portion integrally formed with at least one of the forward and aft end plates and extending in an axial direction, the seal carrier extension portion seated in an axial extension of the first substantially T-shaped slot formed in the stationary component; and at least one additional seal seated within a second substantially T-shaped slot formed in the seal carrier extension portion.

In still another exemplary but nonlimiting embodiment, the invention provides a hybrid seal carrier assembly for establishing a seal between a rotating component and a stationary component substantially surrounding the rotating component comprising a first seal element held between forward and aft end plates and adapted to be held within a first slot formed in the stationary component; a seal carrier extension portion integrally formed with one of the forward and aft end plates and extending in an axial direction, the seal carrier extension portion adapted to be seated in an axial extension of the first slot formed in the stationary component; and a second seal element seated at least partially within a second slot formed in the seal carrier extension portion; wherein the first seal element comprises a brush seal, and the second seal element comprises at least one honeycomb seal.

The invention will now be described in connection with the drawings identified below.

### BRIEF DESCRIPTION OF THE DRAWINGS

FIG. 1 is a schematic side elevation of a combined brush/honeycomb seal for use between a turbine stator and a turbine rotor in accordance with an exemplary but nonlimiting embodiment of the invention;

FIG. 2 is a schematic side elevation of a combined brush/honeycomb seal in accordance with another exemplary embodiment; and

FIG. 3 is a schematic side elevation of a combined brush/honeycomb seal in accordance with still another exemplary embodiment.

### DETAILED DESCRIPTION OF THE INVENTION

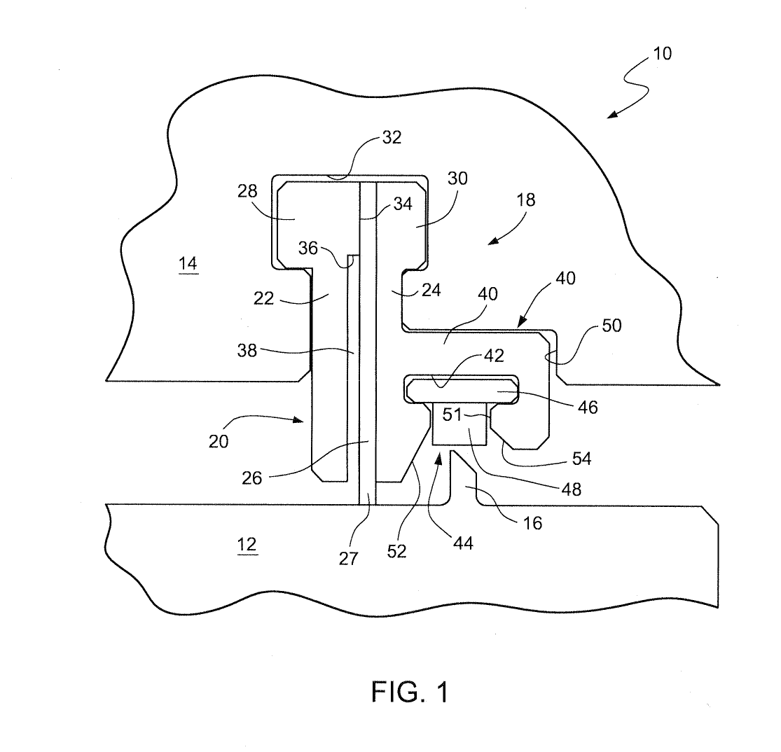

With reference to FIG. 1, a rotor/stator configuration 10 is partially shown, and includes a rotatable turbine rotor 12 and a surrounding, stator component 14.

The rotor 12 is formed to include at least one radially-projecting seal tooth 16 that interacts with the hybrid seal assembly 18 described below.

The seal carrier assembly (or simply, seal carrier) 18 includes a brush seal component 20 including a radially-oriented front plate 22 and a substantially parallel back plate 24 sandwiched about a plurality of bristles (or bristle pack) 26 (also referred to as a first seal element). It will be appreciated that the seal carrier 18 is made up of arcuate segments which, when installed in the stator 14, form an annular seal surrounding the rotor 12. The radially outer portions of the front and back plates 22, 24, are formed to include enlargements or flanges 28, 30 that impart an overall T-shape to the brush seal component 20. This configuration allows the seal carrier 18 to be received within a corresponding substantially T-shaped, annular slot, (or first slot) 32 formed in the stator 14.

The front plate 22 engages the radially outer end of the bristle pack 26 along a radially-oriented surface portion 34, and is offset at 36, establishing a radial gap 38 along the remainder of the radial length of the bristle pack 26, thus permitting the bristle pack to flex during operation of the turbine.

In accordance with one exemplary but nonlimiting embodiment, the seal carrier 18 is formed with an axially-extending side plate 40 (or axial extension), projecting axially from the back plate 24, and formed with its own radially-oriented T-shaped slot (or second slot) 42. The T-shaped slot 42 receives a honeycomb seal component 44. The honeycomb seal component 44 includes a mounting plate or backing 46 that supports the honeycomb seal element (or second seal element) 48. The honeycomb seal land element 48 is located so as to interact with the rotor seal tooth 16. Like the overall seal assembly 18, the honeycomb seal component 44 is also made up of arcuate segments, each seal segment 18 supporting an arcuate honeycomb seal segment.

In the exemplary embodiment, the tip 27 of the plurality of bristles 26 project radially to the same position, higher position or lower position relative to the radially inward projection of the second seal element 48.

In order to accommodate the axially-extending side plate 40, a groove 50 is formed in the stator to one side of, or adjacent the first T-shaped slot 32. The stem portion of the second T-shaped slot 50 is formed to include oppositely tapered entry surfaces 52, 54, extending from a narrow neck portion 51 with surface 52 extending further in the radial inward direction so as to enable the back plate 24 to provide extended support for the bristle pack 26.

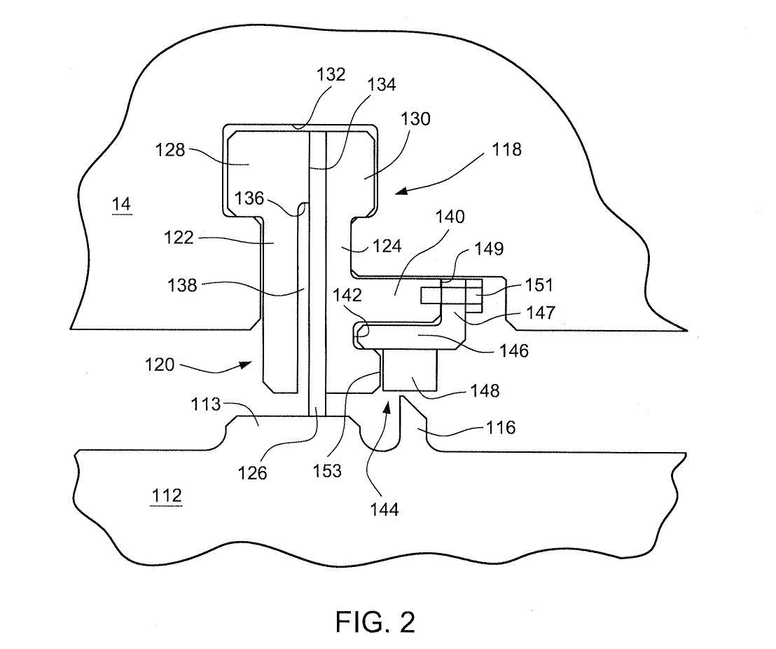

FIG. 2 illustrates an alternative but nonlimiting embodiment of a combined brush/honeycomb seal. For convenience, various of the reference numerals (but with the prefix “1” added) are used to designate corresponding components. In this alternative arrangement the axially-extending side portion or plate 140 is formed such that the second slot 142 is open-ended on one side such that the mounting or backing plate 146 of the honeycomb seal 148 can be bolted directly to the side plate 140 by means of a radial flange 147 that abuts an axial edge 149 of the side plate 140. The bolt 151 extends through the flange 147 directly into the side plate 140 to thereby secure the honeycomb seal 148 to directly to the seal carrier 118. Note also that in this arrangement, the brush seal 126 interacts with a raised seal land 113 on the turbine rotor 112 and that the aft plate 130, rather than having a tapered surface 52 as in the FIG. 1 embodiment, is now formed with a radial surface 153 which provides full backing for the honeycomb seal 148.

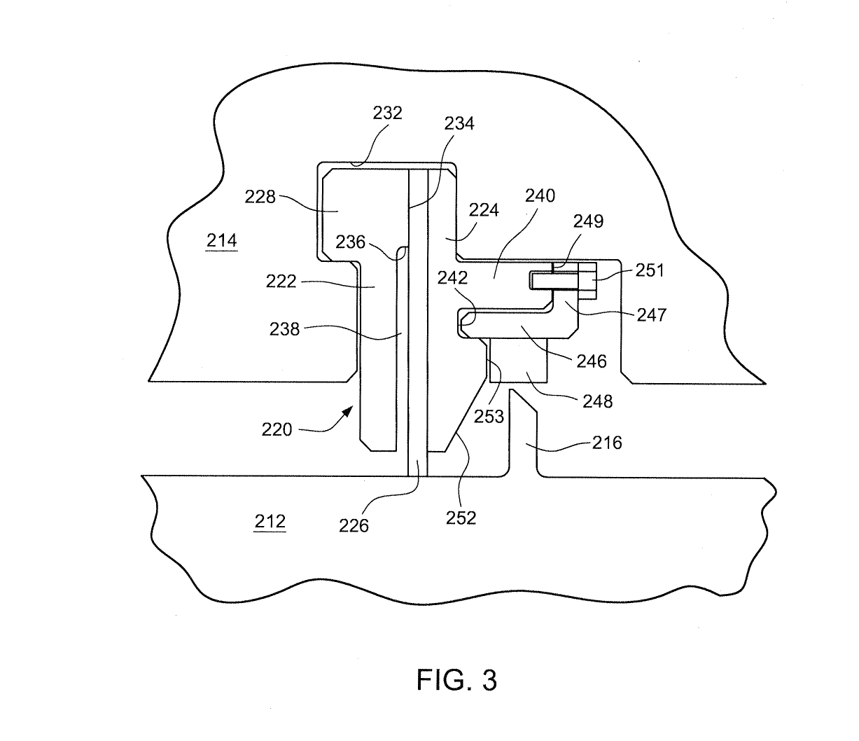

FIG. 3 represents further exemplary but nonlimiting embodiment that is similar to the embodiment described above in connection with FIG. 2 particularly with respect to the modified honeycomb seal backing plate 246, radial flange 247, axial edge 249 and bolt 251. In this embodiment, however, the rotor configuration is more similar to that shown in FIG. 1 except that the radially-extending tooth 16 has a significantly greater radial height than the tooth 16 in FIG. 1. In this arrangement, the aft plate 224 of the brush seal 226 is similar to the aft plate 30 in FIG. 1 but surface portion 252 is extended and also includes an extended radial surface 253 which provides full backing support for the honeycomb seal 248.

In other exemplary embodiments, the axially-extending side plates 40, 140 and/or 240 may extend in the opposite axial direction from the front plates 22, 122 and/or 222.

In still another exemplary embodiment, axially-extending side plates, or axial extensions 40, 140 and/or 240, may extend in opposite directions from both the front plates 22, 122 and/or 222 and the back plates 24, 124 and/or 224 each axial extension supporting one or more honeycomb seals.

It will also be appreciated that the axially-extending side plate(s) may support two or more side-by-side seal elements, depending on the number of opposed rotor teeth.

It will also be appreciated that the axially-extended side plate(s) may support other seals, such as abradable-coating seals as substitutes for, or in addition to, honeycomb seals.

The seal elements may also be arranged at an angle to the rotor, i.e., with a slant in either axial direction, relative to the rotor.

The invention described herein provides a compact design which makes possible tighter cold gaps, and provides flow resistance in series which increases the resistance to flow which, in turn, improves performance. The honeycomb or other seal element carried by the seal carrier also acts as a reliable back-up to the adjacent brush seal, and enables easy maintenance and/or replacement of the seals.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A hybrid seal carrier for establishing a seal between a rotating component and a stationary component substantially surrounding the rotating component, the hybrid seal carrier comprising:
a first seal element held between forward and aft end plates and adapted to be held within a first slot formed in the stationary component; and a second seal element seated within a second slot formed in one of said forward and aft end plates.

2. The hybrid seal carrier of claim 1 wherein said first seal element comprises of bristles between said forward and aft end plates, forming a brush seal.

3. The hybrid seal carrier of claim 1 wherein said one of said forward and aft end plates comprises said aft end plate.

4. The hybrid seal carrier of claim 1 wherein said second slot is substantially T-shaped, with outwardly and oppositely tapered open ends.

5. The hybrid seal carrier of claim 1 wherein said second slot lies radially inwardly of said first slot.

6. The hybrid seal carrier of claim 2 wherein said tip of said plurality of bristles project either radially at same position, a higher position, or a lower position than a corresponding radially inward projection of said second seal element.

7. The hybrid seal carrier of claim 1 wherein said second seal element comprises a honeycomb seal.

8. The hybrid seal carrier of claim 7 wherein said honeycomb seal comprises a backing plate and a honeycomb seal element adapted to interact with at least one radially projecting tooth on the rotating component.

9. The hybrid seal carrier of claim 1 wherein said first seal element comprises a brush seal.

10. The hybrid seal carrier of claim 1 wherein said seal carrier comprises plural arcuate segments, each arcuate segment supporting respective ones of said first and second seal elements.

11. A hybrid seal carrier mounted between a rotating component and a stationary component substantially surrounding the rotating component of a gas turbine compressor, the hybrid seal carrier comprising:
a plurality of bristles held between forward and aft end plates, forming a brush seal which is seated within a first substantially T-shaped slot formed in the stationary component; a seal carrier extension portion integrally formed with at least one of said forward and aft end plates and extending in an axial direction, said seal carrier extension portion seated in an axial extension of said first substantially T-shaped slot formed in the stationary component; and at least one additional seal seated within a second substantially T-shaped slot formed in said seal carrier extension portion.

12. The hybrid seal carrier of claim 11 wherein said stationary component comprises a gas turbine compressor inner casing, said hybrid seal carrier mounted at an aft location of said gas turbine compressor substantially surrounding the rotating component to prevent leakage from high to low pressure regions in a direction of main flow through the compressor.

13. The hybrid seal carrier of claim 11 wherein said at least one of said forward and aft plates comprises both said forward and aft plates.

14. The hybrid seal carrier of claim 13 said seal carrier comprises plural arcuate segments, each arcuate segment supporting respective ones of said first and second seal elements.

15. The hybrid seal carrier of claim 11 wherein said at least one additional seal comprises two or more additional seals.

16. The hybrid seal carrier of claim 11 wherein said tip of said brush seal projects radially inwardly a distance greater than a corresponding radially inward projection of said at least one additional seal.

17. The hybrid seal carrier of claim 11 wherein said at least one additional seal comprises a honeycomb seal and/or an abradable coating seal.

18. A hybrid seal carrier assembly for establishing a seal between a rotating component and a stationary component substantially surrounding the rotating component, the hybrid seal carrier assembly comprising:
a plurality of arcuate segments which, when combined, forms an annular seal carrier, each arcuate segment having a first seal element held between forward and aft end plates and adapted to be held within a first slot formed in the stationary component; a seal carrier extension portion integrally formed with one of said forward and aft end plates and extending in an axial direction, said seal carrier extension portion adapted to be seated in an axial extension of said first slot formed in the stationary component; and a second seal carrier element seated at least partially within a second slot formed in said seal carrier extension portion;
wherein said first seal element comprises a brush seal; and said second seal element comprises at least one honeycomb seal.

19. The hybrid seal carrier assembly of claim 18 wherein said honeycomb seal comprises a backing plate having a first axial portion seated in said second slot and a radial portion fastened to a radial surface of said seal carrier extension portion.

20. The hybrid seal carrier assembly of claim 18 wherein said honeycomb seal comprises a backing plate and a honeycomb seal element adapted to interact with at least one radially projecting tooth on a rotating component.
